(19) United States
(12) Patent Application Publication
(10) Pub. No.: US 2003/0211251 A1
(43) Pub. Date: Nov. 13, 2003

(54) Method and process for powder coating molding

(76) Inventor: Evan R. Daniels, Dallas, TX (US)

Correspondence Address: HAYNES AND BOONE, LLP, 901 MAIN STREET, SUITE 3100, DALLAS, TX, 75202, US

(21) Appl. No.: 10/144,492

(22) Filed: May 13, 2002

(51) Int. Cl. B29C 71/04; B05D 3/06; B05D 1/04; B05D 1/12

(52) U.S. Cl. 427/475; 425/104; 427/180; 427/553; 427/558; 427/385.5

(57) ABSTRACT

A method for applying a powder coating to molding has the steps of providing molding to a coating chamber. Powder is then distributed to the coating chamber. The molding is electrostatically charged to attract the powder. The powder is cured to adhere the molding.

The present invention relates to powder coating and, more particularly to, an improved method of powder coating medium density fiberboard molding in a continuous process.

### BACKGROUND OF THE INVENTION

New construction put in place during August 2001 was estimated at a seasonally adjusted annual rate of $845.5 billion according to the U.S. Commerce Department's Census Bureau. Additionally, expenditures for improvements and repairs of residential properties in the first quarter of 2001 were at a seasonally adjusted annual rate of $169.3 billion. The cost of building materials is a significant portion of the total cost of new construction and home improvement. Consequently, building material manufacturers are continuously searching for new methods of improving their products and reducing their costs to gain a larger portion of this enormous market for building materials.

Molding manufacturers, for example, have developed many manufacturing processes to improve their molding for the consumer. Pre-finished or pre-primed molding is one improvement that is desirable to consumers. Alternative molding materials such as medium density fiberboard (MDF) may also reduce the cost of the molding as compared to stain-grade solid wood molding or even paint-grade finger joint molding. Molding that is made from alternative materials, however, may result in an unfinished molding that lacks the aesthetic qualities of unfinished wood molding, which is important for appealing to the consumer.

Many manufacturers apply a primer or finish coating to the molding to appeal to the consumer. Priming or finishing molding saves the consumer time and effort and also has a more attractive appearance to some builders and consumers. Primer and paint coatings may be applied to the molding in an automated fabrication process. These coatings, however, typically require specialized equipment such as paint sprayers, separate paint booths, ventilation equipment, and driers to apply an attractive or useful coating to the molding. This specialized equipment consequently increases the cost of the finished molding. Priming and painting also produces a variable finish quality according to the amount of material sprayed onto the molding. Overspray may result in drips and wasted primer and paint while color variations may result from using an inadequate volume of primer and paint. Additionally, primers and paints typically contain volatile organic compounds (VOC's) that are vented to the environment. Permits to vent the VOC's and customer perception of the environmental impact of manufacturing processes may also increase the cost or consumer acceptance of the molding.

Powder coating has been used as an alternative to priming and painting many metallic surfaces of building materials and components such as mailboxes, water heaters, window frames, and HVAC equipment, for example. The unique application characteristics of powder coatings provide superior consistency and uniformity of finish without drips, runs, or bubbles. Powder coating provides tough, durable films, enhancing the quality appearance of building materials. In general, performance properties such as impact resistance, flexibility, and corrosion resistance, of powder coatings are better than liquid paints. Powder coated building materials resist cracking, peeling, and marring during handling and normal service use.

Powder coating frequently costs less than priming and painting a product. Production costs are conserved through energy savings, labor costs, rework costs, reduced material usage, reduced waste disposal costs, and an increase in overall line efficiency. One advantage to manufacturers and consumers is that powder coated building materials have a superior quality finish at a reasonable cost.

Powder coating building materials is also more environmentally sound than painting. Environmental issues are a significant interest to the government and consumers. Unlike many primers and paints, powder coatings comply with environmental regulations. Primers and paints often contain VOC's, which can contribute to air pollution and, in some cases, ozone depletion. Powder coatings do not contain VOC's and, therefore, may be perceived by the consumer to be environmentally friendly. Wet painting processes may also generate sludge, which must be disposed in hazardous waste landfills. This disposal increases the cost of the building products. Properly formulated powder coatings generate no hazardous waste. Unused or excess powder may be reclaimed and recycled, which also reduces overall product cost.

It would, therefore, be desirable to have an improved method of finishing molding that does not produce an unsightly finish. It would also be desirable to have an improved method of finishing molding that is not as costly as conventional finishing methods. Further, it would be desirable to have an improved method of finishing molding that is not detrimental to the environment.

### SUMMARY OF THE INVENTION

The present invention is a method for applying a powder coating to molding. This method has the steps of providing molding to a coating chamber. Powder is then distributed to the coating chamber. The molding is electrostatically charged to attract the powder and the powder is cured to adhere the molding.

In one embodiment of the invention, a system for powder coating molding has a molder to supply molding into a coating chamber and powder dispenser to distribute powder to the molding. The system also has a curing device to cure the powder that is distributed on the molding.

In another embodiment of the invention, a process for powder coating molding has the steps of conveying molding to a powder coating chamber and coating the molding with powder. The powder is then cured to adhere the coating to the molding.

### BRIEF DESCRIPTION OF THE DRAWINGS

For a more complete understanding of the present invention, including its features and advantages, reference is now made to the detailed description of the invention, taken in conjunction with the accompanying drawings of which:

FIG. 1 is a schematic view of a powder coating process that depicts an embodiment of the present invention; and

FIG. 2 is a schematic plan view of a powder coating process that depicts an embodiment of the present invention.

### DETAILED DESCRIPTION OF THE INVENTION

While the making and using of various embodiments of the present invention is discussed in detail below, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

A method of powder coating molding according to one embodiment of the present invention has many desirable features that were previously unavailable to those in the business of powder coating. Although methods for powder coating wood are known, economically powder coating molding presented several problems such as the difficulty of efficiently housing lengths of molding in a powder coating booth.

Powder coating objects typically requires that a hangar ground the object so that the object and the powder have opposite electrical charges. This opposite charge uniformly attracts the powder to surface of the object where the powder may be cured. Curing the powder results in a desirable finish being formed on the object.

Hanging the molding in conventional powder coating booths, however, is impractical because of the typically long lengths of the molding. Additionally, the production volume required to produce economical molding prohibits manually hanging each length of molding. As will be described in more detail with reference to the figures, one embodiment of the present invention produces powder coated molding without the added expense of hanging individual lengths of molding in a powder coating booth.

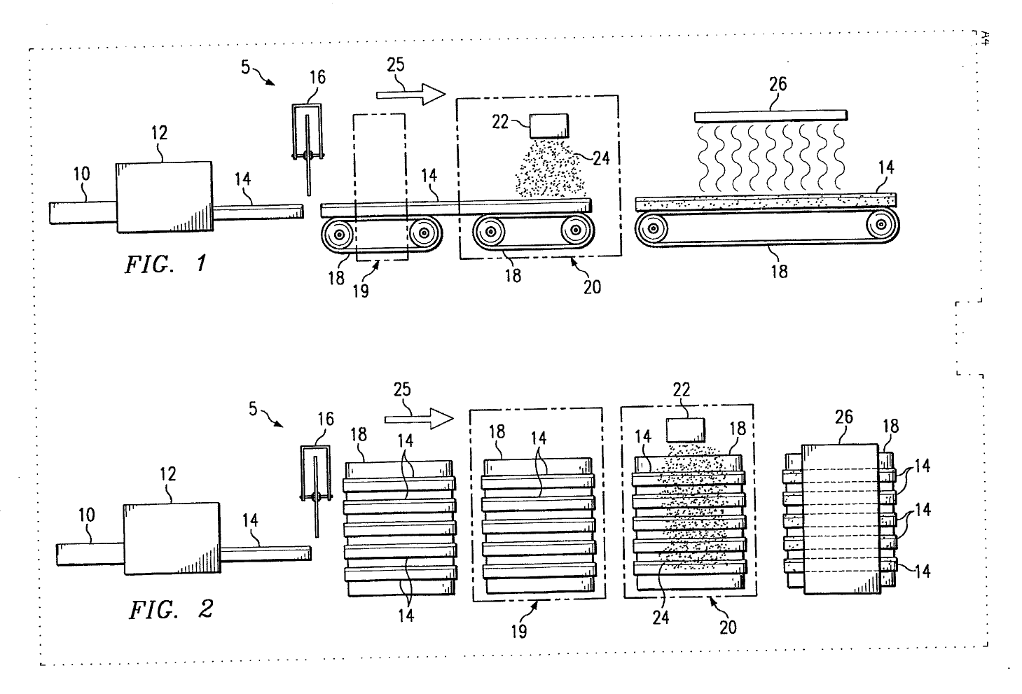

Referring now to the figures and, in particular to FIG. 1, in one embodiment of a molding powder coating apparatus 5, a molding blank 10 is formed in a molder 12 to produce molding 14. The molding blank 10 may be wood, MDF or the like. The molder 12 may produce a variety of different molding profiles according to customer desires. For example, the molding 14 may have a simple rectangular profile or the molding 14 may have a very ornate profile according to the forming capabilities of the molder 12. Additionally, the molder 12 may also be configured to produce banisters and balusters. Powder coating ornate profiles allows for complete coating coverage, even in the most intricate details of molding 14.

A cutoff saw 16 may cut the molding 14 to specified lengths before the molding 14 is conveyed to subsequent coating processes. Alternatively, preformed and precut molding 14 may also be powder coated in the coating apparatus 5. One or more conveyors 18 move the molding 14 through the coating apparatus 5. A preheater 19 may be used to preheat the molding 14. Although not necessary, the preheater 19 helps to produce a better finish on the molding 14. The conveyor 18 then conveys the molding 14 into a powder coating booth 20. A powder dispenser 22 may be located within the powder coating booth 20 and dispenses a powder 24 to the molding 14. The conveyor 18 conveys the molding 14 through the powder coating booth 20 in the direction indicated by arrow 25. The conveyor 18 supports and electrically charges the molding 14 as the molding 14 is conveyed through the powder coating booth 20. A curing device 26 cures the powder 24 after the powder 24 has been applied to the molding 14.

The conveyor 18 may be a typical endless belt-type conveyor that is known to those having ordinary skill in conveyors. The conveyor 18 may also be configured to hang the molding 14 in a vertical orientation. The conveyor 18 may be modified to oppositely charge the molding 14 relative to the powder 24. An opposite charge between the powder 24 and the molding 14, as will be apparent to those having ordinary skill in powder coating, is necessary to attract the powder 24 to the molding 14. The conveyor 18, therefore, may have one or more electrical contacts (not shown), which electrically contact the molding 14 as the molding 14 is conveyed through the powder coating booth 20. Alternatively, the conveyor 18 may be made from electrically conductive material, such as metal and the like, which electrically contacts the molding 14 as the molding 14 is conveyed through the powder coating booth 20.

The conveyor 18 conveys one or more lengths of molding 14 through the powder coating booth 20. The conveyor 18 may be configured to convey multiple lengths of molding 14 oriented in a side-by-side arrangement depicted in FIG. 2. Conveying multiple lengths of molding 14 improves the efficiency of a manufacturing operation. Multiple lengths of molding 14 may be loaded onto the conveyor 18 and conveyed through the powder coating booth 20 at a relatively high conveyor speed to continuously apply the powder 24 to the lengths of molding 14. Although FIG. 2 depicts the lengths of molding 14 in a lengthwise side-by-side orientation, the lengths of molding may also be oriented widthwise according to the configuration of a particular powder coating booth 20 or manufacturing operation. Those having ordinary skill in powder coating will be aware that conveyor speed may be limited by the speed at which a desired volume of powder 24 may be deposited or applied to the molding 14. Additionally, the conveyor speed may be limited by how fast the applied powder 24 may be cured.

The powder coating booth 20 may be a typical powder coating booth for powder coating operations that is known to those having ordinary skill in powder coating. The powder coating booth 20 must be large enough to accept one or more lengths of molding 14 for powder coating. The powder dispenser 22 may be a typical dispenser known to those having ordinary skill in powder coating, such as the corona method dispenser or the triboelectric dispenser, for example. Other methods of applying powder 24 to the lengths of molding 14 will be apparent to those having ordinary skill in powder coating.

The powder 22 may be, for example, powder of the type described in U.S. Pat. No. 5,907,020 or 6,077,610 to Correll et al., U.S. Pat. No. 5,721,052 to Muthiah et al, or U.S. Pat. No. 5,714,206 to Daly et al. These patents are all assigned to Morton International, Inc. and disclose powder coating systems that are suitable for coating wood-based products. The powder 22 may be configured to produce a smooth or a textured finish on the lengths of molding 14. In some instances, a wood grain texture, for example, may be produced by configuration of the powder 22. Other desirable finish characteristics will be apparent to those having ordinary skill in powder coating wood-based products.

The curing device 26, which may incorporate an infrared, ultraviolet, or thermal curing process, for example, cures the powder 22 after the powder 22 is applied to the lengths of molding 14. The powder 22 is configured to cure at temperatures that will not adversely affect the molding 14. As discussed above with reference to coating speed, the conveyor speed may also be limited by the rate that the curing device 26 is capable of curing the powder 22 on the molding 14.

Whereas the invention has been shown and described in connection with the preferred embodiment thereof, it will be understood that many modifications, substitutions and additions may be made which are within the intended broad scope of the appended claims. There has therefore been shown and described an improved powder coating system that accomplishes at least all of the above stated advantages.

What is claimed is:

1. A system for powder coating molding comprising:
a molder to supply molding into a coating chamber;
a powder dispenser to distribute powder to the molding; and
a curing device to cure the powder that is distributed on the molding.

2. The system of claim 1, wherein the molding is made from medium density fiberboard.

3. The system of claim 1, wherein the powder is cured by infrared light.

4. The system of claim 1, wherein the powder is cured by ultraviolet light.

5. The system of claim 1, wherein the powder is thermally cured.

6. A method of applying a powder coating to molding comprising the steps of:
providing molding to a coating chamber;
distributing powder to the coating chamber;
electrostatically charging the molding to attract the powder; and
curing the powder to adhere the molding.

7. The method of claim 6, wherein the step of curing the powder is by thermal curing.

8. The method of claim 6, wherein the step of curing the powder is by infrared light.

9. The method of claim 6, wherein the step of curing the powder is by ultraviolet light.

10. The method of claim 6, wherein the molding is medium density fiberboard.

11. The method of claim 6, wherein the step of providing the molding to the coating chamber is by directly providing the molding from a molder to the coating chamber.

12. The method of claim 6, further comprising the step of preheating the molding prior to providing the molding to the costing chamber.

13. A process for powder coating molding comprising:
conveying molding to a powder coating chamber;
coating the molding with powder; and
curing the powder.

14. The process of claim 13, wherein the powder is cured by ultraviolet light.

15. The process of claim 13 wherein the powder is thermally cured.

16. The process of claim 13, wherein the powder is cured by infrared light.

17. The process of claim 13, wherein the molding is formed and conveyed to the powder coating chamber in a continuous process.

18. The process of claim 13, further comprising preheating the molding before conveying the molding to the powder coating chamber.

19. The process of claim 13, wherein the molding is a banister.

20. The process of claim 13, wherein the molding is a baluster.

21. The process of claim 13, wherein the molding is conveyed generally vertically into the powder coating chamber.
